(19) United States
(12) Patent Application Publication
(10) Pub. No.: US 2005/0051981 A1
(43) Pub. Date: Mar. 10, 2005

(54) Laundry caddy

(76) Inventors: Kelly V. Wallace, Forney, TX (US); Calvin R. Wallace, Forney, TX (US)

Correspondence Address: Stephen R. Greiner, Esquire;GREINER LAW OFFICES, P.C., Suite 110, 6701 Democracy Blvd., Bethesda, MD, 20817, US

(21) Appl. No.: 10/654,883

(22) Filed: Sep. 5, 2003

(51) Int. Cl. B62B 1/10

(52) U.S. Cl. 280/47.26

(57) ABSTRACT

A laundry caddy including a box having a bottom wall with a front wall and a pair of opposed side walls and being secured to, and extending upwardly therefrom. The box also includes a top wall that is hingedly secured to one of the opposed side walls and a back wall and that is hingedly secured to one of the opposed side walls. The top wall and the back wall are each capable of moving between a closed condition wherein access to the interior of the box is not easily obtained and an open condition wherein access to the interior of the box is easily obtained. A pair of wheels is secured to the bottom wall of the box. A handle is secured to the box and extends upwardly therefrom. A pair of latches is secured to the box for selectively retaining the top wall and the back wall in a closed condition.

### FIELD OF THE INVENTION

The present invention relates generally to special receptacles or packages for linens, articles of apparel and like items.

### BACKGROUND OF THE INVENTION

Moving laundry from place to place has never been easy. Such tends to be bulky and, regardless of whether laundered items are folded, some seem to always fall from a load being carried in one's arms. To reduce this backbreaking burden, hampers and carts of various sorts have been developed that permit laundry to be wheeled about. Unfortunately, none of these things are known to be particularly easy to fill and empty.

### SUMMARY OF THE INVENTION

In light of the problems associated with the known laundry receptacles, it is a principal object of the invention to provide a laundry caddy that can be wheeled from place to place and that is easy to load and unload. The laundry caddy in accordance with the present invention can be filled through its top or back and, then, closed to selectively retain its contents within the laundry caddy. Unloading of the laundry caddy can also be accomplished through its top or back. Thus, laundry can be moved to and from high shelves, countertops, washing machines, and low drawers with minimal stooping, bending or effort.

It is another object of the invention to provide a laundry caddy of the type described that is ventilated to prevent the formation of mildew and to aid in drying wet or damp items placed within such.

It is an object of the invention to provide improved elements and arrangements thereof in a laundry caddy for the purposes described which is lightweight in construction, inexpensive to manufacture, and dependable in use.

Briefly, the laundry caddy in accordance with this invention achieves the intended objects by featuring a ventilated box having a front wall and a pair of opposed side walls being integrally formed with, and extending upwardly from, a bottom wall. The box also includes a top wall that is hingedly secured to one of the opposed side walls and a back wall that is hingedly secured to the same side wall. The top wall and the back wall are each capable of independently moving between a closed condition and an open condition. A pair of wheels is secured to the bottom wall of the box and a pair of legs is secured to the bottom wall of the box remote from the wheels for retaining the box upright. A handle is secured to the front wall of the box and extends upwardly therefrom. A pair of latches is secured to the side wall not carrying the top wall and back wall for selectively retaining the top wall and the back wall in a closed condition.

The foregoing and other objects, features and advantages of the present invention will become readily apparent upon further review of the following detailed description of the preferred embodiment as illustrated in the accompanying drawings.

### BRIEF DESCRIPTION OF THE DRAWINGS

The present invention may be more readily described with reference to the accompanying drawings, in which:

FIG. 1 is a perspective view of a laundry caddy in accordance with the present invention in an open condition to reveal details thereof.

FIG. 2 is a back view of the laundry caddy of FIG. 1.

FIG. 3 is a top view of the laundry caddy.

FIG. 4 is a perspective view of the laundry caddy.

FIG. 5 is a side view of the laundry caddy.

FIG. 6 is an enlarged perspective view of a latch employed in the laundry caddy.

FIG. 7 is an enlarged perspective view of a hinge employed in the laundry caddy.

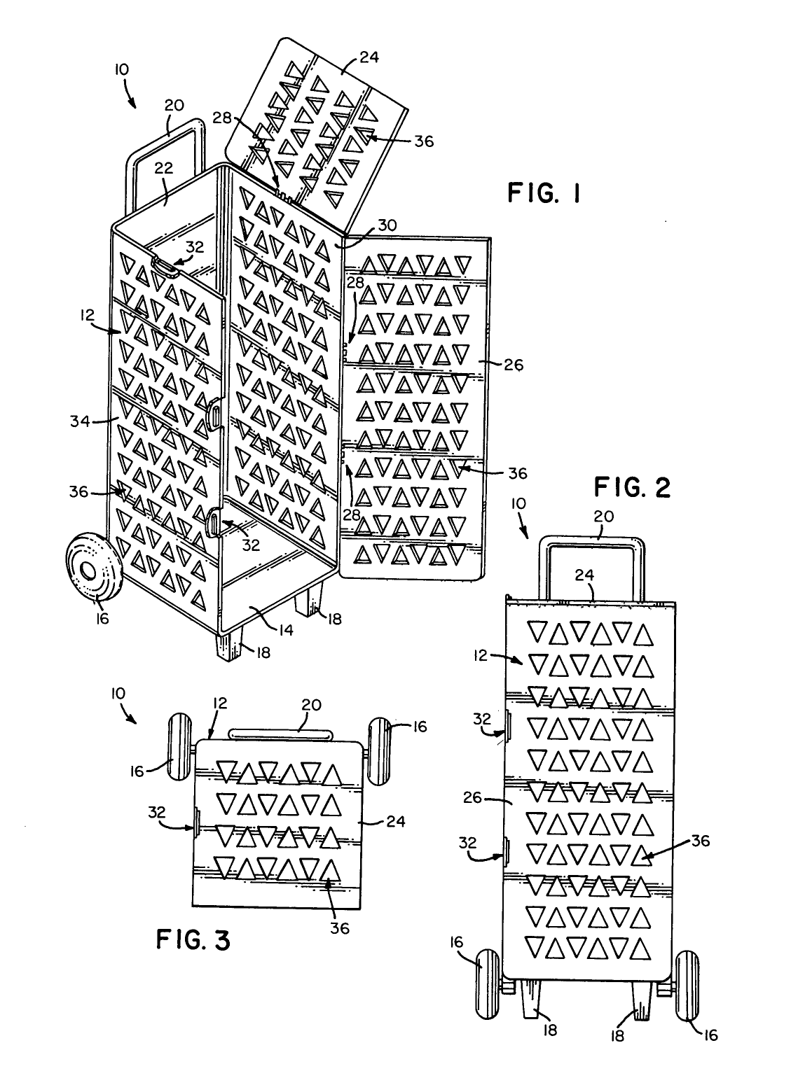

Similar reference characters denote corresponding features consistently throughout the accompanying drawings.

### DETAILED DESCRIPTION OF THE PREFERRED EMBODIMENT

Referring now to the FIGS., the laundry caddy in accordance with the present invention is shown generally at 10. Laundry caddy 10 includes an elongated box 12 dimensioned to hold a predetermined quantity of laundry (not shown). Secured to the bottom wall 14 of box 12 are a pair of wheels 16 for moving box 12 over the ground and a pair of legs 18 for balancing box 12 on wheels 16. A handle 20 is secured to the front wall 22 of box 12 for ease in wheeling box 12 about. The top wall 24 and back wall 26 of box 12 are secured by hinges 28 to side wall 30 so as to serve as doors for entry into box 12. Latches 32 are secured to the side wall 34 of box 12 to selectively retain top wall 24 and back wall 26 in a closed condition.

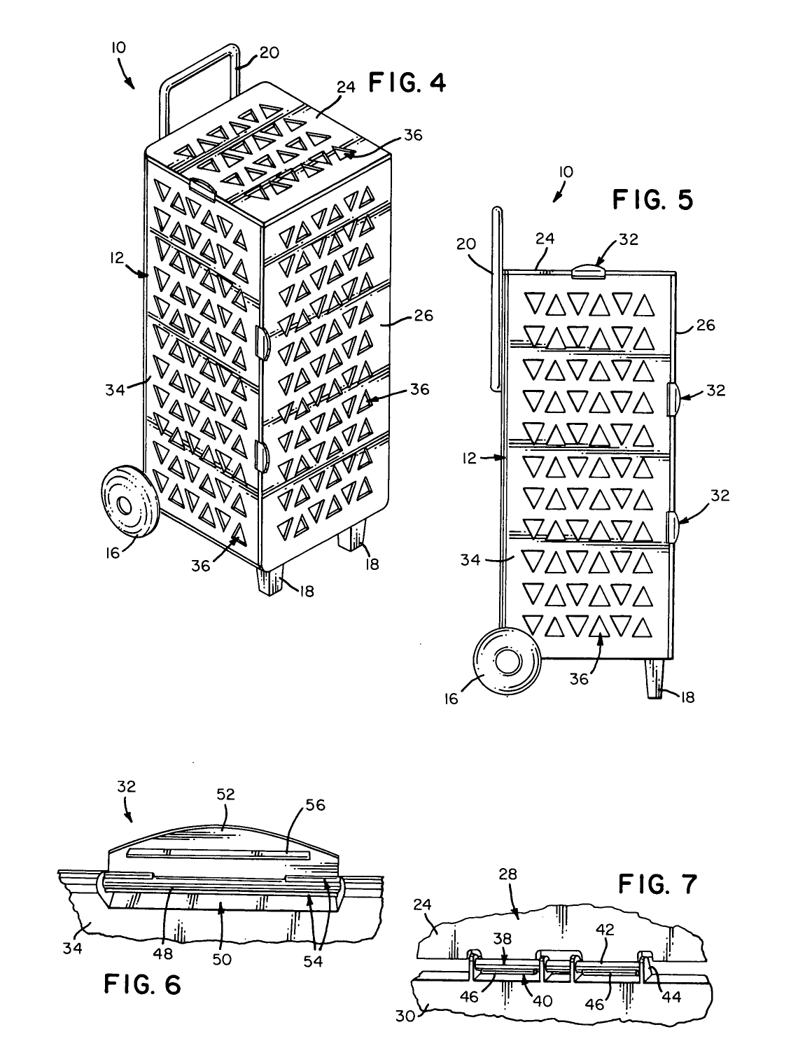

Box 12 is formed of a durable plastic and is rectangular in configuration. Preferably, front wall 22 and side walls 30 and 34 are affixed to the front and opposed sides of bottom wall 14. Hinges 28 join top wall 24 and back wall 26 to side wall 30. When in a closed condition as illustrated in FIG. 4, the back of top wall 24 engages and rests on back wall 26. Top, back, and side walls 24, 26, 30 and 34 are provided with a plurality of small openings 36 the permit air to circulate into box 12, preventing mildew. Although not shown for the sake of drawing clarity, front wall 22 and bottom wall 14 can be similarly provided with openings.

Each hinge 28 includes interlocking male and female parts 38 and 40. Male part 38 has a pivot pin 42 joined by a number of spaced-apart mounting brackets 44 to side wall 30. Female part 40, however, has a pair of J-shaped hooks 46 extending from top and back walls 24 and 26 that clip upon pivot pin 42 between mounting brackets 44. Pivot pin 42 and hooks 46 are dimensioned in such a manner that they permit walls 24 and 26 to pivot easily relative to side wall 30 yet, when tugged with sufficient strength, separate so that walls 24 and 26 can be removed and caddy 10 operated without them.

As may best be seen in FIG. 6, each latch 32 includes a pivot rod 48 spans a notch 50 in side wall 34 and a tab 52 pivotally fastened to rod 48. Rod 48 is integrally formed with side wall 34 and is joined at its opposite ends to side wall 34. Tab 52, however, is provided at its inner end with a C-shaped clip 54 for releasable, and pivotal, engagement with rod 48. The outer end of tab 52 is provided with a retaining flange 56 that overlaps and selectively grasps either top wall 24 or back wall 26 to retain box 12 in a closed condition.

From the foregoing, it should be appreciated that the use of laundry caddy 10 is straightforward. First, tabs 52 are pivoted to disengage retaining flanges 56 from top wall 24 and back wall 26. Next, walls 24 and 26 are pivoted to an open condition as shown in FIG. 1. Then, a number of towels, sheets, or articles of apparel, either folded or unfolded, are positioned in box 12. After loading box 12, walls 24 and 26 are pivoted closed and latched shut to prevent spilling of the contents of box 12. Box 12 is now wheeled to any desired location by pulling gently on handle 20 and unloaded at the convenience of the user. Of course, unloading can take place by pivoting either top wall 24, back wall 26, or both open. Thus, laundry caddy 10 is convenient, easy, and practical to use.

While the invention has been described with a high degree of particularity, it will be appreciated by those skilled in the art that modifications may be made thereto. Therefore, it is to be understood that the present invention is not limited to the sole embodiment described above, but encompasses any and all embodiments within the scope of the following claims.

1. A laundry caddy, comprising:
a box including a bottom wall with front and opposed sides as well as a front wall and a pair of opposed side walls and being secured to, and extending upwardly from, said front and opposed sides of said bottom wall, said box also including a top wall being hingedly secured to one of said opposed side walls and a back wall being hingedly secured to one of said opposed side walls, said top wall and said back wall each being capable of moving between a closed condition wherein access to the interior of said box is not easily obtained and an open condition wherein access to the interior of said box is easily obtained;
a pair of wheels being secured to said bottom wall of said box;
a handle being secured to said box and extending upwardly therefrom; and,
a pair of latches being secured to said box for selectively retaining said top wall and said back wall in a closed condition.

2. A laundry caddy, comprising:
a ventilated box including a bottom wall with front and opposed sides as well as a front wall and a pair of opposed side walls and being secured to, and extending upwardly from, said front and opposed sides of said bottom wall, said box also including a top wall being hingedly secured to one of said opposed side walls and a back wall being hingedly secured to one of said opposed side walls, said top wall and said back wall each being capable of moving between a closed condition wherein access to the interior of said box is not easily obtained and an open condition wherein access to the interior of said box is easily obtained;
a pair of wheels being secured to said bottom wall of said box;
a pair of legs being secured to said bottom wall of said box remote from said pair of wheels for retaining said box in an upright state;
a handle being secured to said front wall of said box and extending upwardly therefrom; and,
a pair of latches being secured to said box for selectively retaining said top wall and said back wall in a closed condition.

3. A laundry caddy, comprising:
a box including a bottom wall with front and opposed sides as well as a front wall and a pair of opposed side walls and being integrally formed with, and extending upwardly from, said front and opposed sides of said bottom wall, said box also including a top wall being hingedly and removably secured to a first one of said opposed side walls and a back wall being hingedly and removably secured to a first one of said opposed side walls, said top wall and said back wall each being capable of moving between a closed condition wherein access to the interior of said box is not easily obtained and an open condition wherein access to the interior of said box is easily obtained, and said top, back and opposed side walls being provided with a plurality of ventilation openings;
a pair of wheels being secured to said bottom wall of said box;
a pair of legs being secured to said bottom wall of said box remote from said pair of wheels for retaining said box in an upright state;
a handle being secured to said front wall of said box and extending upwardly therefrom; and,
a pair of latches being secured to the second one of said opposed side walls for selectively retaining said top wall and said back wall in a closed condition.
